(19) United States
(12) Patent Application Publication
(10) Pub. No.: US 2022/0271608 A1
(43) Pub. Date: Aug. 25, 2022

(54) Motor Housing and Method for Producing a Motor Housing

(71) Applicant: Fraunhofer-Gesellschaft zur Förderung der Angewandten Forschung E.V., München (DE)

(72) Inventors: Franz-Josef WÖSTMANN, Bremen (DE); Jonas KLEI, Bremen (DE)

(73) Assignee: Fraunhofer-Gesellschaft zur Förderung der Angewandten Forschung E., München (DE)

(21) Appl. No.: 17/631,526

(22) PCT Filed: Jul. 30, 2020
(86) PCT No.: PCT/EP2020/071609

§ 371 Date: Jan. 31, 2022

(30) Foreign Application Priority Data
Jul. 31, 2019 (DE) 10 2019 211 440.7

(51) Int. Cl. H02K 5/18; H02K 5/20; H02K 15/14

(52) U.S. Cl. CPC H02K 5/18; H02K 5/207; H02K 15/14

(57) ABSTRACT

A motor housing for an electric motor may have an inner part having a hollow-cylindrical base body and at least one rib arranged on the outside of the base body and a casing slipped over the inner part and contacting the at least one rib. A cooling channel may be formed between the inner part and the casing.

The application relates to a motor housing for an electric motor and a method for producing a motor housing for an electric motor.

Electric motors, which are increasingly being used in the automotive industry, typically have a housing accommodating a stator and transmitting acting forces between the stator and connected elements, such as an automotive body.

The motor housings constitute complex technical components that have to meet certain technical requirements and have to be designed differently depending on the intended application.

Against this background, it is the object of the present invention to propose a high-capacity motor housing and a production method therefor, in order to enable the production of electric motors that is economical and preferably as flexible as possible and adaptable to different requirements.

This is achieved by a motor housing according to independent claim 1 or according to claim 17 and by a method according to claim 18. Advantageous developments result from the dependent subclaims and from the description and the figures.

Accordingly, a motor housing for an electric motor is proposed, the motor housing comprising an inner part and a casing. The inner part comprises a hollow-cylindrical base body and at least one rib arranged on the outside of the base body. The casing is slipped over the inner part and contacts the at least one rib. A cooling channel is formed between the inner part and the casing.

The proposed motor housing has the advantage of being able to be produced at low cost. In particular, it can be produced in different sizes and adapted for specific applications, wherein a complex modification of the production process and/or the tools required therefor are preferably eliminated.

A method according to the invention for producing a motor housing for an electric motor, in particular the motor housing defined above, comprises a step for producing an inner part having a hollow-cylindrical base body and at least one rib arranged on the outside of the base body. The method also comprises producing a casing. In a step of the method, the casing is slipped over the inner part, so that the casing contacts the at least one rib and a cooling channel is formed between the inner part and the casing.

Flexible and cost-effective production of the motor housing can thereby be implemented.

Motor power can be scaled by the length of the housing, while the diameter remains unchanged. The motor housing can then be produced in different lengths, for example, depending on the desired performance of the motor to be produced.

A stator of the electric motor, for example, can be inserted into an inner cavity of the hollow-cylindrical base body, either directly or, for example, using an additional bushing. The cooling channel then runs outside the inner part and can be charged, for example, by a cooling medium in order to cool the motor. The cooling channel can be designed to be fluid-tight for this purpose.

There can be a press fit between the casing and the inner part in the motor housing. In one possible embodiment, apart from the press fit, there is no further connection between the casing and the inner part. The press fit can be produced by slipping the casing over the inner part. In other possible embodiments, the casing and inner part can for instance also be joined together in a materially bonded manner, as an alternative or in addition to the press fit. If a materially bonded connection is provided, the method for producing the motor housing can correspondingly comprise a step for positive substance jointing of the casing to the inner part. For example, welding or gluing can be provided. Spot welding, roller welding, but also thermal joining can be provided in possible embodiments.

The casing may have a conical shape. Alternatively or in addition to the conical shape of the casing, an outer radius of the inner part, which is predetermined by the at least one rib, can increase in an axial direction. The production of the press fit can be promoted and the slipping-on can be facilitated by the conical shape or by the increasing outer radius. In embodiments in which both a conical shape and an increasing outer radius are provided, both can be matched to one another.

The inner part can be produced, for example, by casting, in particular by gravity casting or sand casting or die casting, or by extrusion. The production of the inner part can alternatively or additionally comprise forming. The production of the inner part can furthermore comprise joining, in particular attaching the ribs, for example, by gluing or welding. The use of extruded profiles can enable particularly cost-effective production. Production by casting can also enable economical manufacture, in particular if an integration of a cover plate or of functional elements is intended, or if ribs of complicated design are provided. These aspects are explained in more detail below.

Irrespective of whether the ribs are produced together with the base body or are arranged thereon subsequently, the at least one rib can be post-processed in one step of the method. For example, gaps can be introduced into the at least one rib, for example, by machining during post-processing. Alternatively or additionally, the outer radius increasing in one direction can also be set during post-processing. However, the ribs can also be produced immediately with the increasing outer radius and/or the gaps. For example, the inner part can be cast together with the ribs and their desired properties.

The at least one rib can extend axially on the outside of the base body. In this case, a plurality of ribs is typically provided, for example, at least three ribs or at least four ribs or at most 20 ribs, wherein chambers for a cooling medium are formed between the ribs, which chambers can be connected to one another by possible gaps in one or more of the ribs. The cooling channel is formed by these chambers. If the ribs are alternately recessed or shortened at opposite ends, the cooling channel is given a meandering shape. The at least one rib can run spirally around the base body in the motor housing. This creates a cooling channel that is also spiral-shaped.

The inner part can be made of metal, for example, in particular steel or aluminum.

One or two cover plates can be provided for the motor housing. The cover plates can be arranged such that said cover plates close the hollow-cylindrical base body on both sides, wherein a hole can be provided for a shaft of the motor. Furthermore, at least one contacting opening can be provided in one or in both cover plates, said contacting opening enabling contacting of the cooling channel with the cooling medium. For this purpose, the at least one contacting opening can be located in a radially outer region of the respective cover plate, said region being located at the level of the cooling channel, that is, between the base body and the casing, viewed in the radial direction. One of the cover plates can be produced together with the inner part. In particular, said cover plate can be produced in one piece with the inner part, for example, cast together.

The casing can be produced by forming. To produce the casing, the method can comprise forming and joining, for example. Short cycle times can be achieved by manufacturing the casing by forming.

The casing can be made of metal. In particular, it can be made of sheet metal, steel, aluminum or steel or aluminum alloys. However, the casing can also be made of plastic, in particular made of fiber-reinforced plastic.

In one possible embodiment, the casing is designed in one piece.

The casing can have a spatially varying wall thickness and/or a conical shape. Producing the casing may comprise backward extrusion. Backward extrusion can be used in particular when different wall thicknesses are to be produced within the casing and/or functional elements in the casing.

The application also relates to a motor housing for an air-cooled electric motor, comprising an inner part produced by casting or by extrusion with a hollow-cylindrical base body and a plurality of ribs arranged on the outside of the base body and two cover plates connected to the base body. Said motor housing can advantageously be produced using the method described here or using the devices required for carrying out the method. The flexible and cost-effective production mentioned at the beginning, which is made possible by the devices and methods according to the application, also extends to said motor housing for an air-cooled electric motor.

The inner part of the motor housing of the air-cooled electric motor can be produced in the manner described above, that is, in exactly the same way as the inner part of the motor housing described above, which comprises the casing, and can have the same properties.

It should be mentioned that features that are only described here in connection with the motor housing can also be claimed for the method and vice versa.

The invention is explained in more detail below with reference to figures.

Shown are

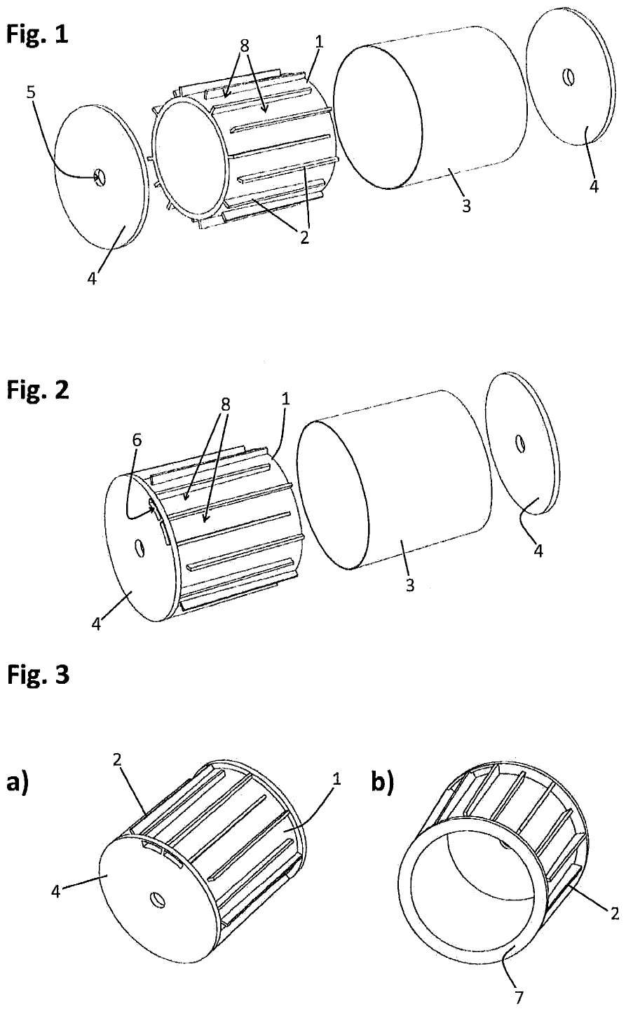

FIG. 1 an exploded view of a motor housing,

FIG. 2 an exploded view of a motor housing having an inner part having a cast-on cover plate,

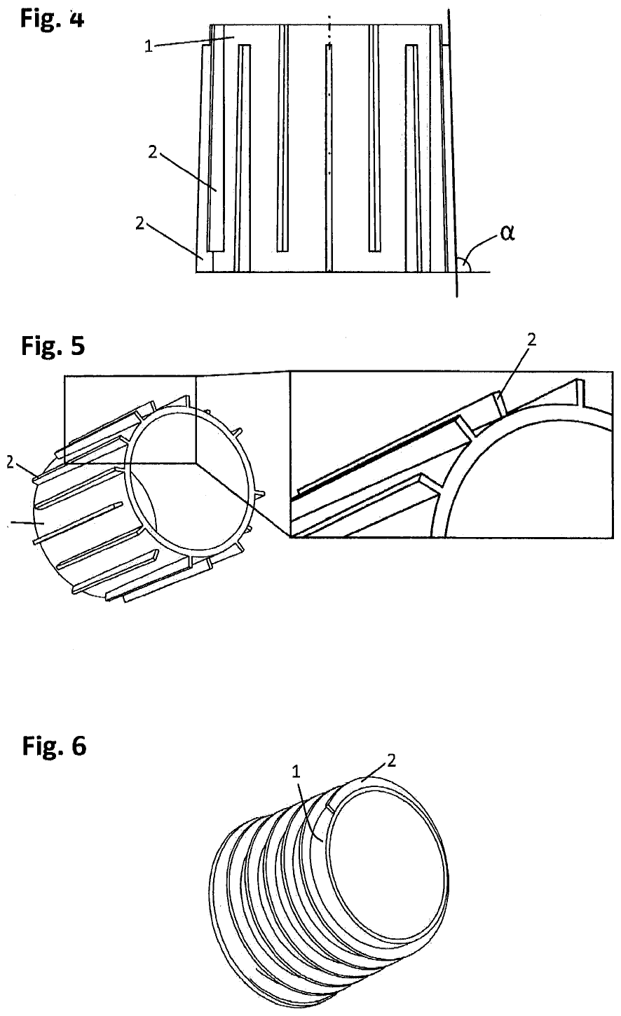

FIG. 3a, b two views of a motor housing, with a directly cast-on cover plate and a peripheral shoulder,

FIG. 4 a side view of an inner part having ribs having a conical outer contour,

FIG. 5 an inner part having a meandering flow channel,

FIG. 6 an inner part having a spiral-shaped flow channel,

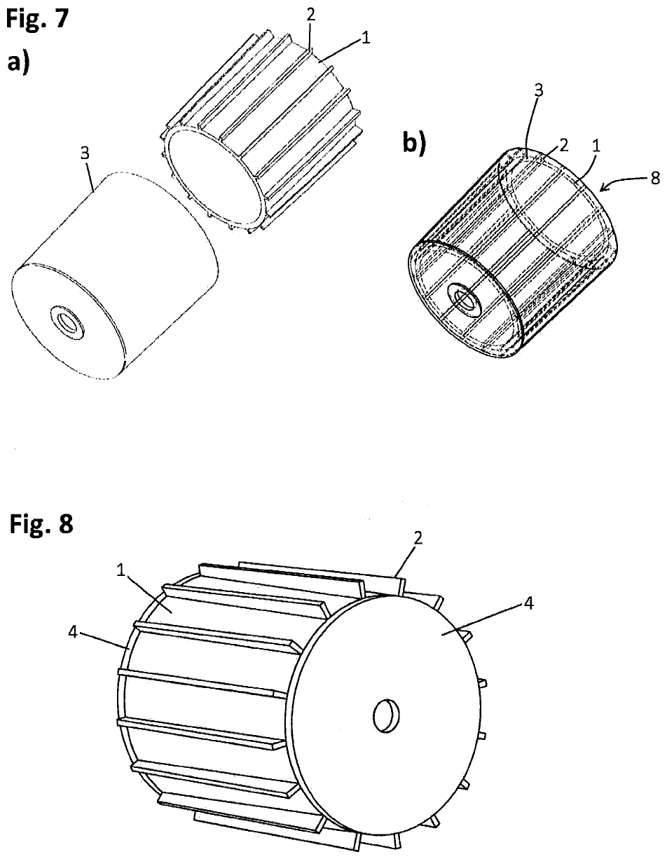

FIGS. 7a, b a motor housing having inner part and final casing, (a) before and (b) after slipping one on top of the other, and

FIG. 8 a motor housing for an air-cooled electric motor.

FIG. 1 shows an exploded view of a motor housing for a medium-cooled electric motor. Said motor housing comprises an inner part having a hollow-cylindrical base body 1 and a plurality of axially running ribs 2 arranged on the outside of the base body. Said motor housing also comprises a casing 3 slipped over the inner part, and two cover plates 4 having holes 5 for a motor shaft.

In the slipped-on state, there is a press fit between the casing 3 and the inner part, wherein the casing is pressed onto the ribs 2 thus forming a fluid-tight cavity between the casing 3 and the base body 1, the cavity being divided into a plurality of chambers by the ribs 2, which together form a fluid-tight cooling channel 8. The ribs are alternately shortened at opposite ends in order to form a meandering cooling channel 8 which can be advantageous for cooling. The cooling channel 8 is marked in the figure on the outside of the inner part, running between the ribs. It should be noted that a channel in the narrower sense between the casing 3 and the inner part is created when the casing 3 is slipped over the inner part.

The stator of the motor can be inserted into an inner cavity of the hollow-cylindrical base body 1 and the motor housing can then be closed at the opposite ends by the cover plates 4.

The inner part can be produced by casting or by extrusion, for example, from steel or aluminum. The production can include the ribs 2; however, said ribs can also be added later. In particular, when the inner part is cast, the shortening of the ribs 2 mentioned above can be produced during casting. However, the shortenings can also be introduced later, for example, by machining. The production of the inner part can also comprise forming.

The casing 3 is designed in one piece and is produced by forming and joining. Said casing is made of sheet metal or aluminum, but can also be made of plastic. The casing 3 can have a spatially varying wall thickness and/or a conical shape. This can promote the press fit, for example. Said casing's production may comprise backwards extrusion.

The casing 3 and the inner part are matched to one another such that the parts can be slipped over and fastened to one another by the press fit, wherein the press fit constitutes the only connection between the casing 3 and the inner part in possible embodiments, while in other, likewise possible embodiments, a positive substance jointing by welding or gluing can also be provided.

FIG. 2 shows a variant of the motor housing shown in FIG. 1. Here the inner part is produced in one piece together with one of the two cover plates 4 in a casting process. The second of the two cover plates can then be attached after the stator has been inserted into the inner cavity.

The co-cast cover plate 4 has contacting openings 6 in a radially outer region, the contacting openings allowing a cooling medium to be applied to the cooling channel 8.

FIGS. 3a and b show the inner part in a cast embodiment with a cast-on cover plate 4 from two different sides. FIG. 3a discloses the cover plate 4 with the contacting openings, while FIG. 3b shows an opposite side on which a circumferential shoulder is arranged. The stator can be inserted directly into the inner part, or a separate bushing (liner) can be placed in the inner part and the stator pressed into the bushing.

FIG. 4 shows that the ribs 2 of the inner part have a height which can be changed in the axial direction, as a result of which an outer radius of the inner part defined by said height changes in said axial direction. The inner part tapers from bottom to top in the illustration shown in the figure. This means that the angle α drawn in as an example for one of the ribs 2 to the base surface of the cylindrical base body is slightly more than 90°. The variable height of the ribs 2, like the gaps or shortenings of the ribs 2 that can also be seen in the figure, can be produced during casting or can be incorporated afterwards.

A corresponding casing, which is slipped over the inner part, can have a conical shape adapted to the angle α.

FIG. 5 again illustrates the discontinuous design of the ribs 2 mentioned, through which the meandering shape promoting cooling is achieved. The ribs 2 are alternately shortened at opposite ends, so that the chambers defined thereby are connected to one another where the ribs 2 are shortened. One of the ribs 2 is not shortened. The chambers arranged on both sides of said non-shortened rib 2 form the first chamber and the last chamber of the cooling channel. Said chambers are each connected to a contacting opening.

FIG. 6 shows an alternative embodiment of the inner part, wherein a spirally running rib 2 is provided on the hollow-cylindrical base body 1 instead of a plurality of axially running ribs 2. Such an inner part can be used instead of the inner parts shown in the previous figures. For example, said inner part can be cast in one piece. The spirally running rib also has a variable height, as a result of which an outer radius of the inner part increases continuously in one direction. A casing 3 having a corresponding conical shape can be slipped on here too.

An alternative embodiment of the motor housing is illustrated in FIGS. 7a and b. The inner part having base body 1 and ribs 2 and the casing 3 is provided again. In this case, however, the cover plate 4 is arranged on the casing. The casing 3 together with the cover plate arranged thereon can then be slipped over the inner part, as shown in FIG. 7b. In the example from FIGS. 7a and b, an extruded inner part and a casing produced by metal forming can be used, for example. A risk of leakage in particular can thereby be reduced here.

It is also possible for one of the cover plates to be arranged on the inner part, in particular cast together therewith, and for a second of the cover plates to be connected to the casing 3.

FIG. 8 shows a motor housing for an air-cooled electric motor. Said motor housing has the inner part comprising the hollow-cylindrical base body 1 with the ribs 2, and two cover plates 4, one of which can be made in particular in one piece with the inner part. The inner part 3 is not surrounded by the casing 3. The ribs 2 then constitute an increase in surface area for air cooling.

### LIST OF REFERENCE NUMBERS

1 base body
2 rib
3 casing
4 cover plate
5 hole
6 contacting opening
7 circumferential shoulder
8 cooling channel
α bevel angle of the ribs

1-26. (canceled)

27. A motor housing for an electric motor, comprising
an inner part having a hollow-cylindrical base body and at least one rib arranged on the outside of the base body and
a casing slipped over the inner part and contacting the at least one rib,
a cooling channel being formed between the inner part and the casing.

28. The motor housing according to claim 27, wherein there is a press fit between the casing and the inner part.

29. The motor housing according to claim 27, wherein the casing has a conical shape.

30. The motor housing according to claim 27, wherein an outer radius of the inner part, given by the at least one rib, increases in an axial direction.

31. The motor housing according to claim 27, wherein the inner part is produced by casting or extrusion.

32. The motor housing according to claim 27, wherein the inner part is made of metal comprised of steel or aluminum.

33. The motor housing according to claim 27, further comprising one or two cover plates.

34. The motor housing according to claim 33, wherein at least one of the cover plates has at least one contacting opening.

35. The motor housing according to claim 34, wherein one of the cover plates is cast in one piece with the inner part.

36. The motor housing according to claim 27, wherein the casing is produced by forming technology.

37. The motor housing according to claim 27, wherein the casing is formed in one piece.

38. The motor housing according to claim 27, wherein the casing has a spatially varying wall thickness.

39. The motor housing according to claim 27, wherein the casing is made of metal comprising sheet metal or steel or aluminum, or is made of plastic comprising fiber-plastic composites.

40. The motor housing according to claim 27, wherein the casing and the inner part are joined to one another in a materially bonded manner.

41. The motor housing according to claim 27, wherein the at least one rib runs spirally around the base body or wherein a plurality of ribs runs axially along the base body.

42. The motor housing according to claim 27, wherein a plurality of ribs runs axially along the base body and at least part of the ribs is recessed or shortened.

43. A motor housing for an air-cooled electric motor, comprising:
an inner part produced by casting or by extrusion having a hollow-cylindrical base body and a plurality of ribs arranged on the outside of the base body and two cover plates connected to the base body.

44. A method for producing a motor housing for an electric motor, comprising the steps:
producing an inner part which has a hollow-cylindrical base body and at least one rib arranged on the outside of the base body,
producing a casing,
slipping the casing over the inner part so that the casing contacts the at least one rib and a cooling channel is formed between the inner part and the casing.

45. The method according to claim 44, wherein the production of the inner part comprises extrusion or casting comprising gravity casting or sand casting or die casting.

46. The method according to claim 45, wherein the production of the inner part comprises an attachment of the ribs.

47. The method according to claim 46, wherein producing the inner part comprises forming.

48. The method according to claim 44, wherein a cover plate is cast together in one piece with the inner part.

49. The method according to claim 44, wherein the casing is produced by forming and joining from metal.

50. The method according to claim 44, comprising a step for positive substance jointing the casing to the inner part by welding or by gluing.

51. The method according to claim 44, wherein gaps in the at least one rib are produced during casting or are subsequently introduced by machining.

52. The method according to claim 44, wherein the production of the casing comprises backward extrusion, wherein different wall thicknesses are produced within the casing and/or functional elements in the casing are produced.
